(19) United States
(12) Patent Application Publication
(10) Pub. No.: US 2025/0145367 A1
(43) Pub. Date: May 8, 2025

(54) QUICK-BIN TRASH CONTAINER LINER SYSTEM

(71) Applicant: 2Percenters Group LLC, Aiken, SC (US)

(72) Inventor: Martin Bernard Pope, Aiken, SC (US)

(73) Assignee: 2Percenters Group LLC, Aiken, SC (US)

(21) Appl. No.: 18/935,029

(22) Filed: Nov. 1, 2024

Related U.S. Application Data
(60) Provisional application No. 63/595,423, filed on Nov. 2, 2023.

(51) Int. Cl. B65F 1/06; B65D 33/28; B65D 65/42; B65D 65/46

(52) U.S. Cl. CPC B65F 1/062; B65D 33/28; B65D 65/42; B65D 65/466; B65F 2210/129

(57) ABSTRACT

Described herein are improved liner systems and methods for making same wherein a plurality of liners are removably affixed to one another and nested one within another and an indicator system is associated with the liners to indicate when the unit begins and when it needs to be replaced.

This application claims the benefit of U.S. Provisional Patent Application No. 63/595,423, filed Nov. 2, 2023, the disclosure of this application is expressly incorporated herein by reference in its entirety.

### TECHNICAL FIELD

The subject matter disclosed herein is generally directed to an improved trash container liner system and methods for making same wherein the container liners are grouped and fastened to one another for ease of use and accessibility as well as indicate when a user should prepare to replace the container liner system with a new system.

### BACKGROUND

Waste container liner systems are most commonly considered a single “trash bag” that lines the interior of a waste receptacle. While usable and common, several issues exist with these systems. Foremost, this arrangement is “single use” in that once the container liner is full of refuse the user must remove the liner from the container and insert another liner into the container.

Various prior attempts include implementations such as U.S. Pat. No. 11,613,411, Cobler et al., directed to a trash bag having an elastic drawstring. The elastic drawstring trash bag features an integrated short seal comprising an inner seal, an outer seal, and an intermediate seal. The integrated short seal functions to reduce the upper opening of the drawstring trash bag, while the elastic drawstring utilized with the bag provides a bag that allows the bag to fit snugly on many common trash receptacles. (Abstract) However, this system is limited to a single liner inside a trash container designed to “snugly” fit the container.

U.S. Pat. Pub. No. 2023/0070325, Wood et al., is directed to a bag of polymeric film and a method to make the bag. The bag can be comprised of a front panel and a rear panel. The front and rear panels can each be comprised of multiple layers of film. The bag can be formed from a collapsed bubble of polymeric film that has been folded in half so that opposing edges of the collapsed bubble form an opening of the bag. One of the layers of the folded bubble can be split adjacent to an edge of the collapsed bubble and a draw tape film can be inserted between the layers of the folded and collapsed bubble. The collapsed bubble can further be embossed by a pattern that can provide enhanced properties to bags formed from the folded bubble. (Abstract) This system, too, is directed to a single use liner.

U.S. Pat. Pub. 2023/0072724, Feng, is directed to the combination of an adjunct material and a delivery particle. The delivery particle comprises a benefit agent core material and a shell encapsulating the core material, along with a process for forming such a delivery particle and articles of manufacture. The shell is the reaction product of: i) an isocyanate or acid chloride or acrylate with ii) an amine-containing natural material having free amino moieties, and iii) an a, β-unsaturated compound, the a, β-unsaturated compound forming C—N covalent bonds with the amine moieties of the natural material. The delivery particle of the invention has improved release characteristics, with enhanced degradation characteristics in OECD test method 301B. (Abstract) Again, this is directed to a single use material.

U.S. Pat. No. 9,925,745, Jean-Mary et al., discloses a multi-layer thermoplastic film including a first film of thermoplastic material, a second film of thermoplastic material bonded to the first film, and an odor control component disposed between the first film and the second film. A method of manufacturing a multi-layer thermoplastic film coextruding a plurality of layers to form a first film, coextruding a plurality of layers to form a second film, disposing at least one odor control component on at least one of the first film and the second film, and bonding the first and second films together such that the at least one substance is disposed between the first film and the second film. (Abstract) This attempt also fails to disclose multiple, integrated liners.

U.S. Pat. No. 7,114,534, Chomik et al., provides a composite trash container that includes a container body defining a trash chamber and an opening that provides access to the trash chamber; a support mounted to the container body adjacent the opening, the support having a flange extending therefrom that is configured for rotational mounting a tubing cassette above the trash chamber, wherein the support encloses less than all of the opening to the trash chamber so that trash can be passed through the opening and into the trash chamber; a tubing cassette rotationally mounted to the flange of the support; and a tube sealing means for forming trash packets from tubing that is dispensed from the tubing cassette. (Abstract) This attempt also fails to disclose multiple, integrated liners for use and removal from the system.

U.S. Pat. No. 7,168,591, Miller, discloses a trash bag dispenser, for receiving a trash bag continuously joined to and separable from another trash bag, for receiving a trash receptacle and for dispensing the trash bag from the trash receptacle. The trash bag dispenser comprises a housing for containing the trash bag and a cover having a slot therein for guiding the trash bag there through. The cover is movably connected to the housing and integral therewith for allowing the cover to capture the trash bag and to allow the trash bag to freely move when urged through the slot. A closure, comprises a snap button fastener. The trash bag dispenser is attachable to an interior of the trash receptacle with an adhesive backed hook and loop type fastener. (Abstract) However, this system fails to disclose nested, ready to use liners, but instead requires the user to “unroll” each bag for use and secure same to a perimeter of the trash container.

U.S. Pat. Pub. No. 2005/0258177, Woodson, meanwhile, provides, a storage unit or dispenser for trash can liners that comprises a receiving member having a generally rectangular cross section. In one embodiment designed for mounting to an outside wall of a trash receptacle, the receiving member includes a slot though which trash can liners may be dispensed from a box or roll then through the dispenser wall. In another embodiment, the storage unit serves as a base for a trash receptacle, and is sized to receive and store one or more consumer retail size boxes or rolls of trash bags. The storage unit or dispenser provides a ready supply of trash can liners near at hand and eliminates the need to search for liners. (Abstract) This example also fails to provide “ready to use” liners nested within the container.

U.S. Pat. No. 8,317,055, Zawrotny et al., discloses a trash bag receptacle with trash bag dispenser system has an open top, a bottom floor, and a front wall. The front wall of the container has a slotted opening which extends from the bottom floor upwards along substantially the entire length of the front wall. A channel member with an open top and bottom extends inward into the container, enclosing the slotted opening within the container. A base section supporting the container has an interior space in which a roll of trash bags is rotatably mounted. A single trash bag from the roll is threaded from the interior space and through the channel. The trash bag exits from the open top of the channel where its perforation is separated from the roll of trash bags. The adjacent, next trash bag on the roll remains in the channel member. A new, clean trash bag is thus easily accessible to the user by simply pulling the next trash bag which is exposed through the open top of the channel member. (Abstract) This attempt also fails to disclose nested, ready to use liners, but instead requires the user to “unroll” each bag for use and secure same to a perimeter of the trash container.

U.S. Pat. No. 8,807,378, Kaberna, defines a trash can system and component elements. Folded or interfolded trash bags are provided in a container beneath a flexible insert. The flexible insert provides separation between a trash bag in an operative position within the trash can, and provides support to the container against the pulling operation performed by a user to pull a full trash bag out of the container and dispense a new, refill trash bag from the container. According to another exemplary embodiment, folded or interfolded trash bags are provided in a tray which slidably connect to a lid associated with a box disposed in the trash can. (Abstract) This attempt also fails to disclose nested, ready to use liners. Instead, trash bags are adhered at a distal end of a first bag to proximal end of a second bag and requires securing the “second” or “new” liner to a perimeter of the trash container for use.

U.S. Pat. No. 9,493,302, Rousso et al., provides a device that includes a housing, a lid, a bucket frame, a pair of members, and a foot pedal. The foot pedal is operatively associated with the lid and the pair of members so that the lid is in the closed position and the pair of members is in the non-use position when the foot pedal is in the upper position. Further, the foot pedal is operatively associated with the lid and the pair of members so that the lid is in the open position and the pair of members is in the use position when the foot pedal is in the lower position. (Abstract) However, this system, too, fails to disclose nested, ready to use liners, but instead “pinches” waste into discrete, separate units within a continuous film enclosure.

US-2019/0031438, Zipperlen et al., provides nesting multi-layered trash bags for trash receptacles. The bags preferably each have an elastic member providing compression to securely hold the nested trash bags in relative position until filled and removed. The elastic member is a rubber element or alternatively an elastic drawstring. A rigid member can be utilized in conjunction with the nested trash bags to facilitate the installation of the multi-layered trash bags into the trash can. (Abstract) However, this systems requires installation of a separate ring around the trash receptacle perimeter and further requires the user to nest the bags into one another. This is in direct contrast to Applicant's system that installs the inserts already nested to one another as well as the system indicating when the user should prepare to replace the system. In contrast, the current disclosure provides a trash bag already inserted into another trash bag ten times over while being attached to one another around the circumference of each bag's drawstring housing belt using a weak adhesive, the user will only need to install the product of the current disclosure once for every ten disposals of a trash bag. Unlike Zipperlen's patent, the current disclosures “sticky note” method does not require the time and effort of placing a trash bag in a trash receptacle ten times, but allows them to place ten trash bags in the receptacle at once with the effort and sleek seamless look of one bag. The current disclosure also has color indication drawstrings to let the user know if they are using a newly installed unit and if they are on the last trash bag of the unit.

U.S. 2011/0007986, Eytcheson et al, discloses a multi-compartment plastic bag suitable for collecting and retaining a quantity of refuse and a quantity of recyclable items. The multi-part bag provides longitudinal compartments for the receipt of refuse or recycling. The longitudinal compartments are each sealed on three sides with a fourth (top) edge open for the insertion of refuse/recycling. The multi-compartment bag is initially constructed as a single unit and may be separated into the multiple components along one or more perforated mid-seams. Grab handles may be formed near the upper edge through perforated cutouts. The multi-compartment bag is designed to be used in standard single compartment trash receptacles. The construction of the bag lends itself to manufacture in a continuous multilayer sheet with longitudinal sealed seams along each edge of the multilayered sheet and at least one partial longitudinal sealed seam along an interior line or mid-seam of the multi-layered sheet. The mid-seam may be perforated for the later separation of the multiple bag components. Grab handle perforations (in the nature of a partial or complete oval or circle) may be made at the appropriate intervals. (Abstract) This application fails to disclose nested, ready to use liners.

CN 203781131, [symbol] [symbol] [symbol] , discloses a multi-bag nested garbage bag, which comprises a garbage can, a garbage bag body, thermal glue positions, adhering paper and point breakage positions, wherein two sides of the garbage bag body are respectively provided with one thermal glue position, multiple of layers of bags are adhered together through thermal glue, the point breakage positions are arranged around the thermal glue positions, the outer layers of the thermal glue positions are provided with the adhering paper, and the bag is fixed in the garbage can through the adhering paper. The garbage bag disclosed by the utility model is adhered to the outer side of the edge of the garbage can through the adhering paper on the thermal glue positions, so that the garbage bag can cover in the garbage can, the use is convenient, when a used garbage bag needs to be removed, the bag in the innermost layer can be taken out by tearing the connection between the bag and the thermal glue positions from the point breakage positions, a new garbage bag does not need to be arranged, thus continuous use is facilitated, the garbage bag is degradable, and green and environment-friendly effects are realized. (Abstract) In contrast, the current disclose provides liners affixed to one another at their respective drawstrings, not adhered to the container via an additional paper layer affixed to the container via additional adhesive. Meanwhile, with respect to the current disclosure, CN 203781131 provides the convenience of multiple layers of trash bags in one, it is only meant for smaller, not-so-heavy trashcans. The method they use to hold the trash bags around the opening of the receptacle is two points of paper adhered to the outer lip of the receptacle, the current disclosure utilizes drawstrings tightly fixed around the opening of the receptacle, like current trash bags are already. This is important because due to the current disclosure's method, it allows the weight of the trash that gradually increases to be held and supported by the bag by distributing the weight all around the bag, as opposed to the weight of the trash applying strain on just the two paper stickers attached to the can. The current disclosure product is not just meant for small office trash cans that get filled with paper and an empty Starbucks coffee cup or two, but is designed to withstand the weight of everyday family trash disposal, and more, industrial disposal, construction work, public trash cans, etc. Imagine what would happen if the adhesive papers were to get wet.

Accordingly, it is an object of the present disclosure to provide an improved system for allowing users easy access to trash receptacle liners while also allowing easy and convenient deployment of additional liners once the current liner is at capacity or the user desires to remove particularly noxious or offensive waste from the receptacle.

Citation or identification of any document in this application is not an admission that such a document is available as prior art to the present disclosure.

### SUMMARY

The above objectives are accomplished according to the present disclosure by providing in one instance improved liner systems wherein a plurality of liners possessing removable adhesive strips are affixed to one another and nested one within another and a color coded indicator system is associated with the liners to indicate when the system needs to be replaced.

The disclosure further provides methods for making improved liner systems wherein a plurality of liners possessing removable adhesive strips are affixed to one another and nested one within another and a color coded indicator system is associated with the liners to indicate when the system needs to be replaced.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a single liner of the system of the current disclosure affixed to a trash container.

FIG. 2 shows a series of liners affixed to one another.

FIG. 3 shows a series of liners of the system of the current disclosure affixed to a trash container.

FIG. 4 shows a further illustration of a series of liners of the system of the current disclosure affixed to a trash container.

FIG. 5 shows a single liner of the current system standing alone.

FIG. 6 shows at: (A) a wire diagram of one embodiment of the current disclosure with the liners removed from a waste container; and at (B) a shaded view of one embodiment of the current disclosure with the liners removed from a waste container.

FIG. 7 shows at: (A) a wire diagram of one embodiment of an assembled device of the current disclosure; and at (B) a shaded diagram of one embodiment of an assembled device of the current disclosure.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, “control” can refer to an alternative subject or sample used in an experiment for comparison purpose and included to minimize or distinguish the effect of variables other than an independent variable.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

The term “belt” as used herein refers to the housing compartment for the drawstring and location where an adhesive may be applied.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the systems or liners described herein can be presented as a combination kit. As used herein, the terms “combination kit” or “kit of parts” refers to the systems, compounds, compositions, liners, and any additional components that are used to package, sell, market, deliver, and/or provide the combination of elements or a single element, such as the liner system or a single liner, contained therein. Such additional components include, but are not limited to, packaging, blister packages, containers, and the like. When one or more of the compounds, compositions, liners, and any additional components described herein or a combination thereof, can be provided a single embodiment or separate embodiments. When the systems, compounds, compositions, liners, and any additional components described herein or a combination thereof and/or kit components are not provided simultaneously, the combination kit can contain each article or other component in separate embodiments. The separate kit components can be contained in a single package or in separate packages within the kit.

In some embodiments, the combination kit also includes instructions printed on or otherwise contained in a tangible medium of expression. The instructions can provide information regarding the content of the systems, compounds, compositions, liners, and any additional components, safety information regarding the content of the systems, compounds, compositions, liners, and any additional components, information regarding installation, indications for use, and/or recommended uses for the systems, compounds, compositions, liners, and any additional components contained therein. In some embodiments, the instructions can provide directions and protocols for installing and use the systems, compounds, compositions, liners, and any additional components described herein to a subject in need thereof. In some embodiments, the instructions can provide one or more embodiments of the methods for providing any of the systems and methods described in greater detail elsewhere herein.

The current disclosure provides a liner system for trash receptacles wherein multiple liners are provided simultaneously and may be deployed sequentially, one after another. The liners are affixed to one another via a low tack glue or other adhesive on the belt at the upper perimeter of each liner to enable easy removal from a waste receptacle. Further, a marker or indicator may be incorporated into various of the liners to indicate when a unit has just been installed and when a user should replace the system depending on the number of liners remaining.

Drawstrings for trash bags are typically made from plastic materials, specifically polyethylene or polypropylene. These materials are chosen for their durability, flexibility, and resistance to moisture, which are essential characteristics for a trash bag drawstring.

Polyethylene and polypropylene drawstrings can withstand the rigors of tying and cinching without breaking or fraying easily. They are also resistant to moisture and can handle the wet and messy contents commonly found in trash bags without weakening. Additionally, these plastics are cost-effective, which makes them a practical choice for mass-produced trash bags.

The specific type and thickness of the plastic used for drawstrings may vary depending on the bag's intended purpose and the manufacturer's design preferences. In some cases, drawstrings may be reinforced with additional layers or materials to enhance their strength and durability, especially for heavy-duty trash bags.

Trash bags are typically made from various types of plastic materials, primarily polyethylene (PE) and, to a lesser extent, polypropylene (PP). These plastics are chosen for their durability, flexibility, and cost-effectiveness. The manufacturing process involves extruding and processing these plastics into thin sheets, which are then cut and sealed to create the bags.

Poly tubing, also known as polyethylene tubing, is typically made from polyethylene (PE), which is a versatile thermoplastic polymer. Polyethylene is widely used in various applications due to its excellent combination of properties, including flexibility, chemical resistance, and durability.

Some of the most common trash bag materials include, but are not limited to:

1. **Low-Density Polyethylene (LDPE):** LDPE is a common material used for trash bags. It is known for its flexibility and strength. LDPE trash bags are relatively thicker and can handle a wide range of loads. They are often used for kitchen trash bags and general-purpose garbage disposal.

2. **High-Density Polyethylene (HDPE):** HDPE is a tougher and more rigid plastic compared to LDPE. HDPE trash bags are typically thinner but still strong, making them suitable for lighter loads and applications where cost-efficiency is essential. They are commonly used for commercial and industrial purposes.

3. **Linear Low-Density Polyethylene (LLDPE):** LLDPE is a type of PE that strikes a balance between LDPE and HDPE. It offers good strength and flexibility, making it suitable for a variety of trash bag sizes and purposes. LLDPE trash bags are often used in household and commercial settings.

4. **Polypropylene (PP):** PP trash bags are less common than PE bags but are still used in certain applications. They are known for their strength and puncture resistance. PP bags may be preferred for specific industrial or heavy-duty uses.

5. **Biodegradable and Compostable Materials:** In recent years, there has been an increasing demand for environmentally friendly trash bags made from biodegradable or compostable materials like cornstarch-based polymers. These bags are designed to break down more quickly in composting environments and reduce environmental impact.

The choice of material depends on factors such as the intended use (kitchen, industrial, outdoor, etc.), load capacity, and environmental considerations. Manufacturers may also add features like odor-blocking technologies, drawstrings, or antimicrobial coatings to enhance the functionality of trash bags.

The choice of polyethylene type and tubing specifications depends on factors such as the desired flexibility, strength, chemical resistance, and clarity for the specific application.

Low tack glue dots are commonly used for temporarily adhering plastic and other materials together without leaving a permanent bond. They are useful in various applications, such as crafting, packaging, and temporary assembly. Low tack adhesive products may include:

1. **Removable Adhesive Dots:** Removable adhesive dots are designed to be easily removable without leaving residue on surfaces. Brands like 3M and Scotch offer removable adhesive dots in various sizes and tack levels. These are suitable for temporarily adhering plastic materials.

2. **Glue Dots:** Glue dots are pre-formed adhesive dots that come on a roll or in sheets. They are available in different tack levels, including low tack. They are commonly used for temporarily adhering plastic and other lightweight materials. Glue Dots is a well-known brand in this category.

3. **Repositionable Adhesive Putty:** Adhesive putty, like Blu Tack or similar products, is a versatile option for temporarily adhering plastic surfaces together. It can be easily removed and reused, making it suitable for various applications.

4. **Masking Tape:** While not technically a glue dot, masking tape with a low-tack adhesive can be used to temporarily hold plastic pieces together. It is easily removable and leaves minimal residue.

5. **Temporary Spray Adhesives:** Some temporary spray adhesives are designed to provide a temporary bond that can be easily removed. These can be used for temporarily adhering plastic surfaces together but may require careful application to avoid overspray.

Hot melt pressure-sensitive adhesives (PSA) offer several benefits depending on their specific type and formulation. These adhesives are widely used in various industries for bonding applications due to their versatility and performance characteristics. Some benefits associated with different types of hot melt PSAs include:

1. **Quick Bonding:** Hot melt PSAs bond rapidly upon cooling, making them ideal for high-speed manufacturing processes. They can provide instant adhesion, which increases efficiency in production.

2. **Wide Temperature Range:** Hot melt PSAs maintain their adhesive properties over a broad temperature range, from sub-freezing to elevated temperatures. This makes them suitable for applications exposed to various environmental conditions.

3. **Clean and Easy Application:** Hot melt PSAs are typically applied in a molten state and solidify upon cooling. This application method is clean and eliminates the need for solvents or water, reducing the risk of environmental contamination and providing a neat appearance.

4. **Versatility:** Different types of hot melt PSAs can be formulated to bond to various substrates, including paper, cardboard, plastic, metal, and fabric. This versatility makes them suitable for a wide range of applications.

5. **Strong Bonds:** Hot melt PSAs can offer strong and reliable bonds when properly formulated and applied. They can withstand a range of stresses, including shear, peel, and impact forces.

6. **Removability:** Some hot melt PSAs are designed to be removable, allowing for repositioning or temporary bonding without leaving residue or damaging surfaces.

7. **Low VOC Emissions:** Hot melt PSAs typically have low or no volatile organic compound (VOC) emissions, contributing to a safer and environmentally friendly adhesive option.

8. **Excellent Adhesion to Difficult Surfaces:** Certain formulations of hot melt PSAs are designed for challenging substrates, such as low-energy plastics or heavily textured surfaces.

9. **Resistance to Moisture and Chemicals:** Some hot melt PSAs are formulated to resist moisture, chemicals, and environmental factors, ensuring the bond remains stable in demanding conditions.

10. **Customizable Formulations:** Manufacturers can tailor hot melt PSA formulations to meet specific application requirements, adjusting factors like tackiness, open time, and bond strength.

11. **Compatibility with Equipment:** Hot melt PSAs are compatible with a variety of application methods, including roll coating, spray, extrusion, and more, making them adaptable to different production processes.

It is important to note that the specific benefits of a hot melt PSA will depend on its formulation, which can vary significantly between products and manufacturers. When selecting a hot melt PSA for a particular application, it is crucial to consider factors like substrate compatibility, temperature requirements, bonding strength, and environmental conditions to choose the most suitable adhesive for the job.

The current disclosure also worked with Low profile Glue dots from Uline (½″)
S-10364 Low tack strength
S-10365 Medium tack strength
Link: https://www.uline.com/BL_7551/Dot-Shot-Pro-Dispenser-and-Glue-Dots?keywords=non+adhesive+tape

As well as ADCOTETM HS 33-193
Link: https://www.laminatingadhesiveproducts.com/product/adcote-hs-33-193
Other links to look into: https://www.gluespec.com/chemistries/hot-melt-materials?gclid=CjwKCAjw6p-oBhAYEiwAgg2PgIDYeRHN-q5VNh8Gk1SnCtLE9uCxt7QRV2MSX7KmM5PXYqGzE2RzPROCF7YQAvD_BWE

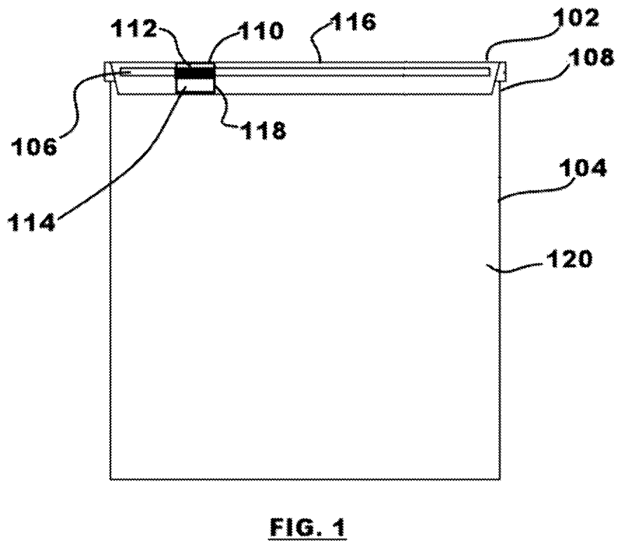

FIG. 1 shows a single liner 102 affixed to waste receptacle 104 and belt 106 to at least partially, if not completely, encircle a perimeter 108 of waste receptacle 104. In one instance, adhesive may be used to attach each liner to another liner at belt 106. The unit is placed and sits in the receptacle the exact same way the trash bag sits in your kitchen trash can right now. This provides a unitary system with multiple bags readily and easily usable. Liner 102 may be polymeric bags manufactured from polymeric film produced using one of several manufacturing techniques well-known in the art. The two most common methods for manufacture of polymeric films are blown-film extrusion and cast-film extrusion. In blown-film extrusion the resulting film is tubular while cast-film extrusion produces a generally planar film. Manufacturing methods for the production of drawstring bags from a web of material are shown in numerous prior art references including, but not limited to, U.S. Pat. Nos. 3,196,757 and 4,624,654, which are hereby incorporated by reference. In blown film extrusion, the direction that the film is extruded is commonly referred to as the machine direction (MD) and the direction perpendicular to the machine direction is commonly referred to as the cross direction (CD).

Liner 102 may be trash bags made from polyethylene, which is a petroleum-based resin that is preferred because of its tear resistance and strength. There are three different types of polyethylene resins used to manufacture trash bags: low-density polyethylene (LDPE) resins, linear low density polyethylene (LLDPE) resins, and high-density polyethylene (HDPE) resins.

LDPE, LLDPE, and HDPE are all polyolefins with unique molecular structures that offer each type of garbage bag different properties.

As an initial matter, the thermoplastic material of liner 102, or multiple liners 102, may include thermoplastic polyolefins, including polyethylene and copolymers thereof and polypropylene and copolymers thereof. The olefin-based polymers may include ethylene or propylene based polymers such as polyethylene, polypropylene, and copolymers such as ethylene vinyl acetate (EVA), ethylene methyl acrylate (EMA) and ethylene acrylic acid (EAA), or blends of such polyolefins.

The term “linear low density polyethylene” (LLDPE) as used herein is defined to mean a copolymer of ethylene and a minor amount of an olefin containing 4 to 10 carbon atoms, having a density of from about 0.910 to about 0.926, and a melt index (MI) of from about 0.5 to about 10. For example, some examples herein use an octene comonomer, solution phase LLDPE (MI=1.1; p=0.920). Additionally, other examples use a gas phase LLDPE, which is a hexene gas phase LLDPE formulated with slip/AB (MI=1.0; ρ=0.920). Still further examples use a gas phase LLDPE, which is a hexene gas phase LLDPE formulated with slip/AB (MI=1.0; ρ=0.926). One will appreciate that the present disclosure is not limited to LLDPE, and can include “high density polyethylene” (HDPE), “low density polyethylene” (LDPE), and “very low density polyethylene” (VLDPE). Indeed, liners 102 made from any of the previously mentioned thermoplastic materials or combinations thereof can be suitable for use with the present disclosure.

Other examples of polymers suitable for use as liners 102 in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

Additional materials that may be incorporated into liners 102 may include slip agents, anti-block agents, voiding agents, or tackifiers. Additionally, one or more implementations of the present disclosure may include films that are devoid of voiding agents. Some examples of inorganic voiding agents, which may further provide odor control, include the following but are not limited to: calcium carbonate, magnesium carbonate, barium carbonate, calcium sulfate, magnesium sulfate, barium sulfate, calcium oxide, magnesium oxide, titanium oxide, zinc oxide, aluminum hydroxide, magnesium hydroxide, talc, clay, silica, alumina, mica, glass powder, starch, charcoal, zeolites, any combination thereof, etc. Organic voiding agents, polymers that are immiscible in the major polymer matrix, can also be used. For instance, polystyrene can be used as a voiding agent in polyethylene and polypropylene films.

Further additives that may include in one or more embodiments include natural oils. For example, the additives may include thyme oil, mint oil, lemon grass oil, tea tree oil, cinnamon bark oil, methyl jasmonate, etc. Yet further additives may include zinc pyrithione (“ZPT”) and copper pyrithione (“CPT”), which inhibit microbial growth.

Belt 106 may comprise a releasable pressure sensitive adhesive. The adhesive may possess durable tack for an aggressive bond, yet is releasable to allow for ease of replacement. Preferably, the adhesive may also be low odor, so it is ideal for use in occupied buildings. Adhesive band may include low tack glues, low tack adhesive sprays forming a band or “stripe” on the liner, “islands” of low tack adhesive spaced apart from one another or a band of adhesive glue forming a continuous “stripe” or “band” on the liner.

The entire unit interacts with the trash receptacle to stay in place just like the drawstring trash bags that are currently used in households today. The belts being perfectly aligned with each other will fold/wrap around the diameter of the receptacle's opening, the applied pressure of the belt folded over the lips of the opening will provide the strength to hold the unit in place while withstanding the weight of the material inserted into the innermost liner

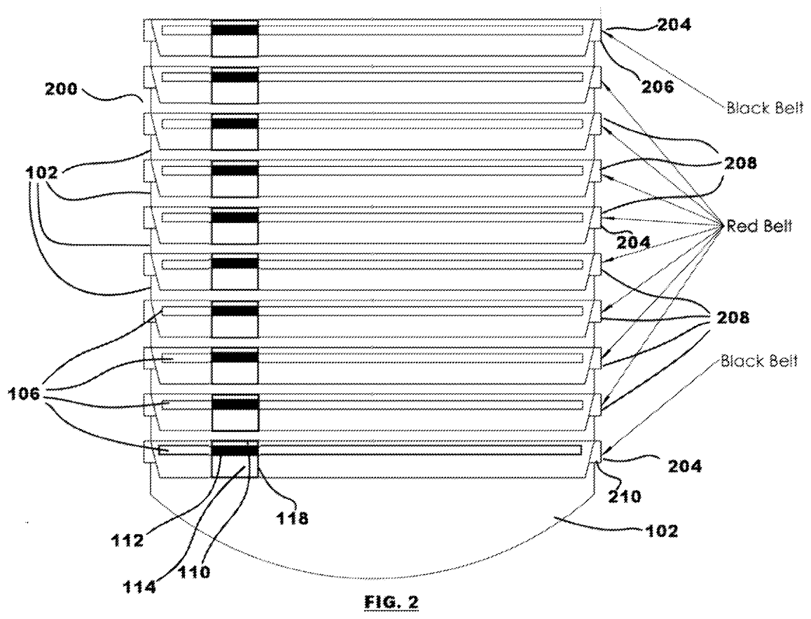

Referring again to FIG. 2, system 200 may include a multi-layered nesting liner system. System 200 may be comprised of a plurality of liners 102. Each liner may be comprised of a first and a second layer of plastic sealed, typically with heat, along three sides to form an envelope or bag. Other sealing methods are contemplated by this application. Furthermore, each liner 102, see FIG. 1, may include a closing member 110. Closing member 110 in this embodiment maybe a drawstring 112, or equivalent, drawstring 112 may be located in channel 114 adjacent opening 116 of liner 102. Alternatively, drawstring may be directly attached to liner 102. Channel 114 has at least one opening 118 where the user can grab drawstring 112 and cinch opening 116 of liner 102. In the preferred embodiment, drawstring 112 can cinch liner 102 closed and grip perimeter 108 of waste receptacle 104 or other container in which liner 102 is placed.

FIG. 2 also shows that system 200 may include visual indicia 204 that indicate the replacement status of the system. Replacement status may be measured in multiple ways, with FIG. 2 showing one embodiment where initial visual indicia 206 shows one color, for example black, with subsequent visual indicia 208, which comprises at least one visual indicia when system 200 is first installed, showing another color, for example red, and a final visual indicia 210 showing a color that differs from the color of subsequent visual indicia 208. Here, initial visual indicia 206 and final visual indicia 210 are shown to be the same color, but the current disclosure is not so limited. Indeed, a spectrum of colors, such as initial indicia visual indicia 206 being dark green and showing differing shades, such as showing a color change from green to faint shades of red including shades of orange and red, across subsequent indicia 208, again, which may comprise at least one liner 102 but may be a plurality of liners 102 nested together, see FIG. 2, and final indicia 210 may be a distinct color such as dark red signifying system 200 has been depleted and needs replacement once liner 102 bearing final indicia 210 is removed from waste receptacle 104. FIG. 2 also shows that the last liner 102 may include an adhesive strip to affix liner 102 to waste receptacle side 120, see FIG. 1.

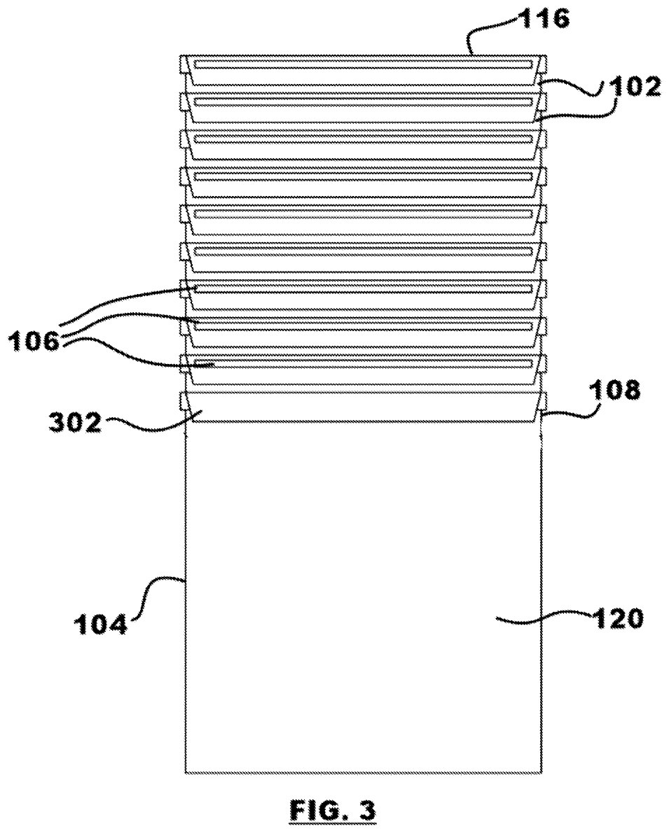

FIG. 3 shows a further embodiment of the current disclosure wherein last liner 302 lacks a belt 106 but the remaining liners 102 possess belt 106.

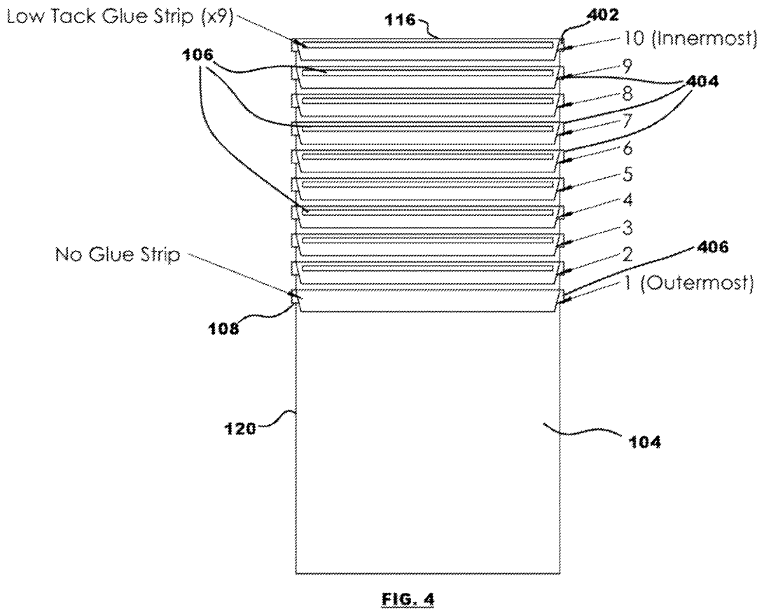

FIG. 4 shows one embodiment wherein ten (10) liners including innermost or first liner 402, eight (8) subsequent liners 404, and outermost or final liner 406. While ten layers are shown, the current disclosure should not be considered so limiting and more or less liners are considered within the scope of the disclosure including 3, 4, 5, 6, 7, 8, 9, 11, or more liners.

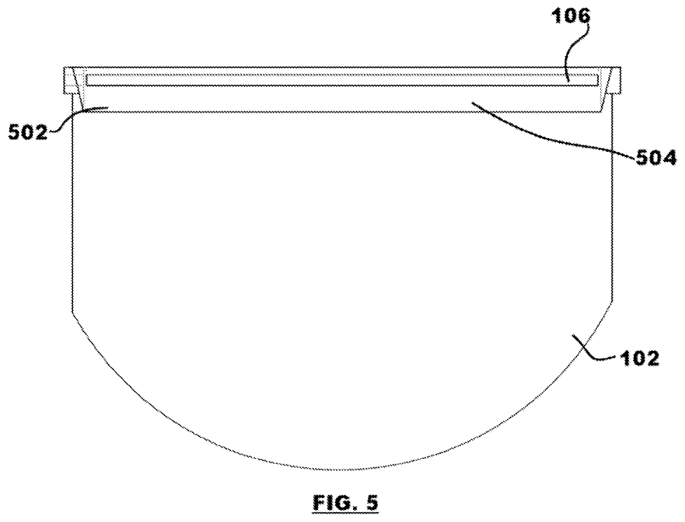

FIG. 5 shows a single liner 102. Liner 102 may include flap 502 that supports belt 106 on the outer surface 504 of flap 502 so that liners 102 may be adhered to one another. In one instance, no adhesive is applied to the outside of the outermost belt 106, again adhesive may only be used to keep the liner 102 affixed to one another at belt 106 until manually removed from each other by the user.

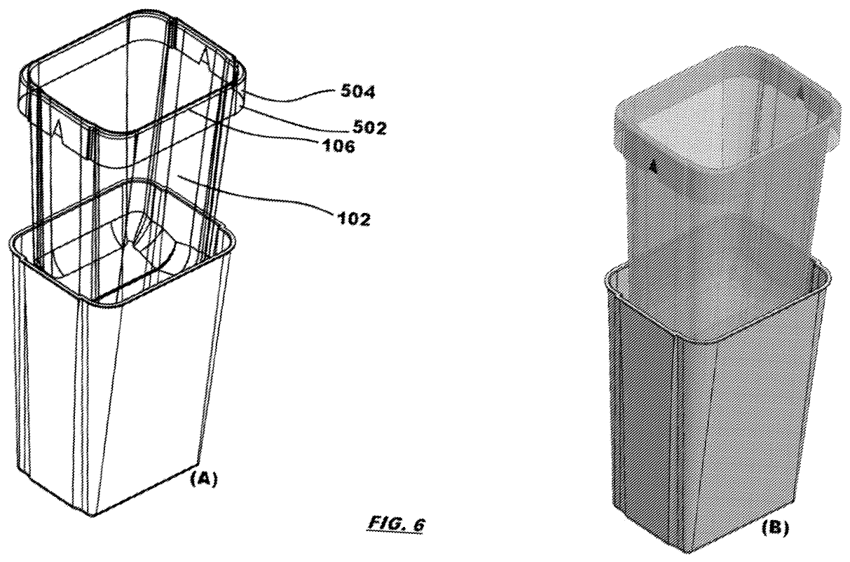

FIG. 6 shows at: (A) a wire diagram of one embodiment of the current disclosure with the liners removed from a waste container; and at (B) a shaded view of one embodiment of the current disclosure with the liners removed from a waste container.

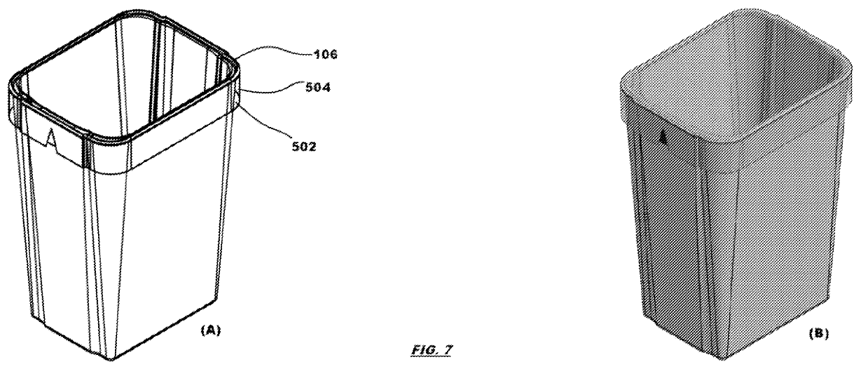

FIG. 7 shows at: (A) a wire diagram of one embodiment of an assembled device of the current disclosure; and at (B) a shaded diagram of one embodiment of an assembled device of the current disclosure.

During use, the user simply grabs the unit, places their thumb in the innermost trash bad that will be indicated by the colors of the drawstrings, forces the unit open by flapping it (forcing air into the innermost trash bag), and places the unit inside of the receptacle and folding the collective belts around the circumference of the opening of the receptacle. When the user decides to remove the innermost bag, they will pull the outermost drawstring (the only drawstring that will be exposed to the user) disengage the adhesive, detach the innermost bag from the rest of the unit, and display a color that indicates that it is not the newest or last bag. The user will remove eight more bags before displaying the drawstring that indicates it is the last bag. After removing the final bag, the processes will start all over again.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

What is claimed is:

1. A trash container liner system, comprising:
a plurality of nested trash liners each including a belt portion that encircles an interior perimeter of a trash receptacle, each liner configured to be sequentially deployed after a prior liner is removed; and
a removable adhesive strip on each of the plurality of liners, the removable adhesive strip configured to adhere one liner to another liner in the plurality of nested liners;
wherein the liner system includes a color-coded indicator on at least one of the liners to signal when the liner system requires replacement.

2. The liner system of claim 1, wherein the removable adhesive strip comprises a low-tack adhesive.

3. The liner system of claim 2, wherein the low-tack adhesive is a glue dot.

4. The liner system of claim 1, wherein the color-coded indicator is positioned on the belt portion of a final liner in the plurality of nested liners.

5. The liner system of claim 1, wherein the belt portion is made of a polyethylene or polypropylene material.

6. The liner system of claim 5, wherein the polyethylene or polypropylene material is selected from the group consisting of low-density polyethylene (LDPE), high-density polyethylene (HDPE), and linear low-density polyethylene (LLDPE).

7. The liner system of claim 1, wherein each liner in the plurality of nested liners further includes a drawstring made of a material selected from the group consisting of polyethylene and polypropylene.

8. The liner system of claim 7, wherein the drawstring is configured to cinch the belt portion around the perimeter of the trash receptacle when pulled.

9. The liner system of claim 1, wherein each liner in the plurality of nested liners is formed from a biodegradable or compostable polymer material.

10. The liner system of claim 1, wherein the liners include an antimicrobial coating to inhibit microbial growth on the liners.

11. The liner system of claim 1, further comprising an additive in the material of the liners, the additive selected from the group consisting of thyme oil, mint oil, lemon grass oil, tea tree oil, cinnamon bark oil, methyl jasmonate, zinc pyrithione, and copper pyrithione.

12. A method for producing a liner system for a trash receptacle, comprising:
forming a plurality of liners, each liner having a belt portion configured to encircle a perimeter of a trash receptacle;
applying a removable adhesive strip to each liner to adhere each liner to another liner in a nested configuration;
incorporating a color-coded indicator on at least one liner to indicate when the liner system should be replaced.

13. The method of claim 12, wherein the step of applying a removable adhesive strip comprises applying a low-tack adhesive in the form of glue dots.

14. The method of claim 12, further comprising forming the belt portion from a polyethylene or polypropylene material selected from the group consisting of LDPE, HDPE, and LLDPE.

15. The method of claim 12, further comprising forming each liner with a drawstring of polyethylene or polypropylene material.

16. The method of claim 12, further comprising adding an antimicrobial coating to each liner to inhibit microbial growth.

17. The method of claim 12, further comprising incorporating an odor control additive in the material of the liners, the additive selected from the group consisting of natural oils, zinc pyrithione, and copper pyrithione.

18. The method of claim 12, wherein the color-coded indicator is placed on the belt portion of the final liner in the nested configuration to signal an impending replacement.

19. A trash liner system, comprising:
a plurality of trash liners nested within each other, each trash liner configured with a belt portion including a removable adhesive for sequential deployment of each liner upon removal of a preceding liner; and
an indicator positioned on a belt portion of a final liner within the plurality of nested trash liners to signal replacement of the liner system.

20. The trash liner system of claim 19, wherein the removable adhesive comprises a pressure-sensitive adhesive compatible with repeated liner deployment and detachment from the trash receptacle.
